(19) United States
(12) Patent Application Publication
(10) Pub. No.: US 2003/0018667 A1
(43) Pub. Date: Jan. 23, 2003

(54) Website using images as a navigational tool for user-created photopages on the internet

(75) Inventors: Thomas J. Hoehn, Rochester, NY (US); Matthew H. Bernius, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/907,868

(22) Filed: Jul. 18, 2001

(51) Int. Cl. G06F 15/00; G06F 17/24

(52) U.S. Cl. 707/513; 707/501.1

(57) ABSTRACT

A website accessible on the Internet includes images submitted by a third party and arranged in a predetermined configuration on the website; and an embedded link in one or more of the images each link respectively corresponding to one of a plurality of third party websites created by the third party, and the link is activated when a user indicates a preference for one of the images.

### FIELD OF THE INVENTION

The invention relates generally to the field of websites on the Internet and, more particularly, to such websites having a plurality of images submitted by consumers wherein each image includes a direct or an indirect link to one of a plurality of third-party websites.

### BACKGROUND OF THE INVENTION

Currently, websites are available on the Internet for displaying information to consumers. As is well known in the art, such web sites may have images and/or text that may be linked for viewing another website containing additional information or images. Such user-friendly images on the websites, however, are not navigational tools for searching a collection of webpages.

Consequently, a need exists for a website that permits consumers to use user-friendly images as a navigational tool for searching a collection of webpages.

### SUMMARY OF THE INVENTION

The present invention is directed to overcoming one or more of the problems set forth above. Briefly summarized, according to one aspect of the present invention, the invention resides in a website accessible on the Internet comprising: (a) a plurality of images submitted by a third party and arranged in a predetermined configuration on the website; and (b) an embedded link in one or more of the images each link respectively corresponding to one of a plurality of third party websites created by the third party, and the link is activated when a user indicates a preference for one of the images.

These and other aspects, objects, features and advantages of the present invention will be more clearly understood and appreciated from a review of the following detailed description of the preferred embodiments and appended claims, and by reference to the accompanying drawings.

Advantageous Effect of the Invention

It is an advantage of the present invention to use images as a navigational tool, which enhances the user-friendliness of on-line searching.

It is that feature of the present invention to provide an embedded link in images of a website, each link respectively corresponding to one of a plurality of third party websites.

It is an object of the present invention to provide a website that searches a collection of webpages using images as the navigational tool.

### BRIEF DESCRIPTION OF THE DRAWINGS

FIG. 1 is a perspective of a computer system for displaying a website of the present invention to a consumer;

FIG. 2 is an illustration of a webpage of the website having a plurality of thumbnail images thereon; and

FIG. 3 is an illustration of an on-line form having query information into which a user inputs information related to the thumbnail images; and

FIG. 4 is an illustration of the links from the thumbnail images to either a third-party website or a high-resolution version of the thumbnail image with a text description and link to a third party website.

### DETAILED DESCRIPTION OF THE INVENTION

In the following description, a portion of the present invention will be described in the preferred embodiment as a software program. Those skilled in the art will readily recognize that the equivalent of such software may also be constructed in hardware.

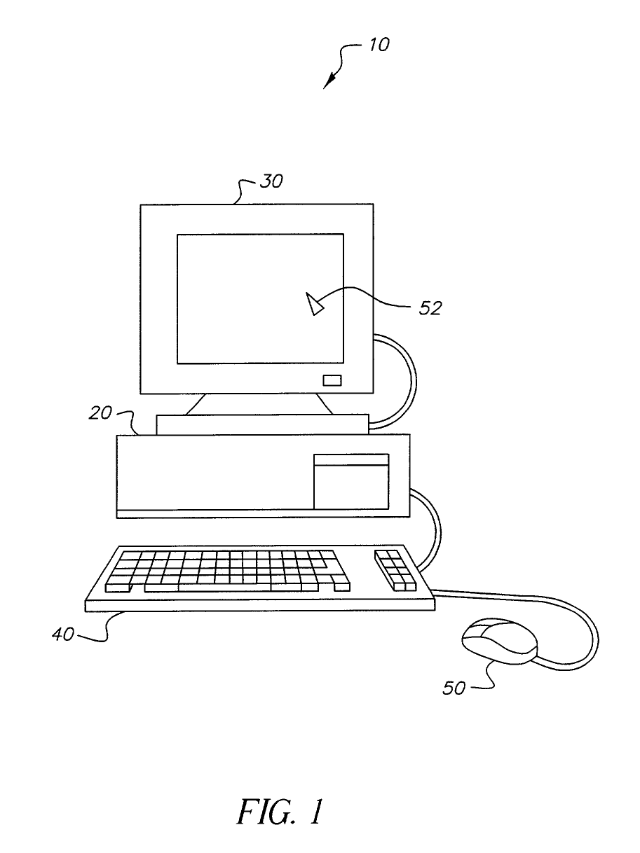

Referring to FIG. 1, there is illustrated a computer system 10 for displaying a website to a user. The computer system 10 includes a microprocessor-based unit 20 for receiving and processing software programs and for performing other processing functions. A display 30 is electrically connected to the microprocessor-based unit 20 for displaying user-related information associated with the software. A keyboard 40 is also connected to the microprocessor based unit 20 for permitting a user to input information to the software. As an alternative to using the keyboard 40 for input, a mouse 50 may be used for moving a selector 52 on the display 30 and for selecting an item on which the selector 52 overlays, as is well known in the art.

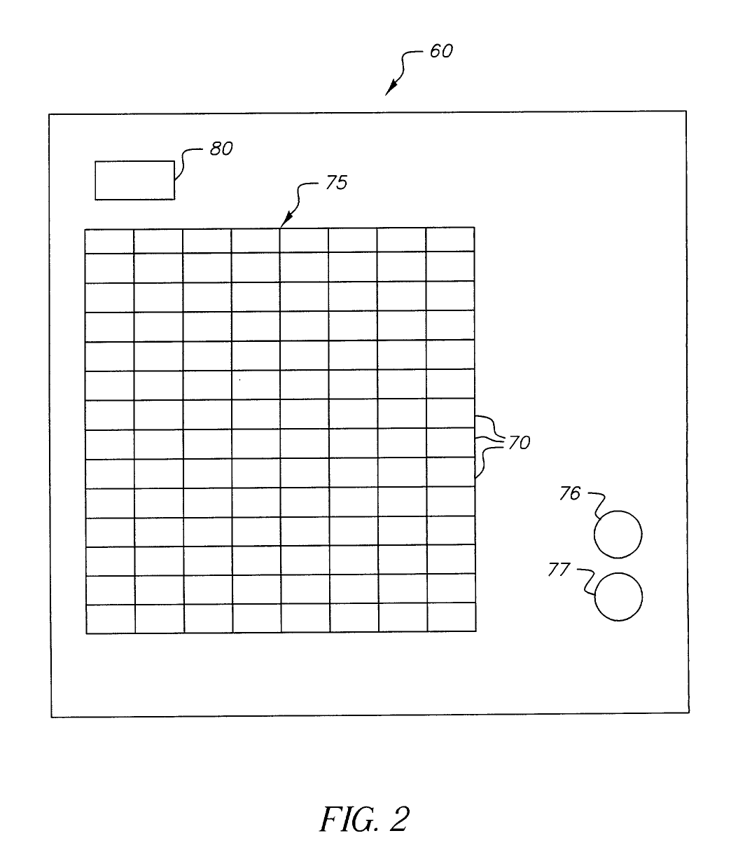

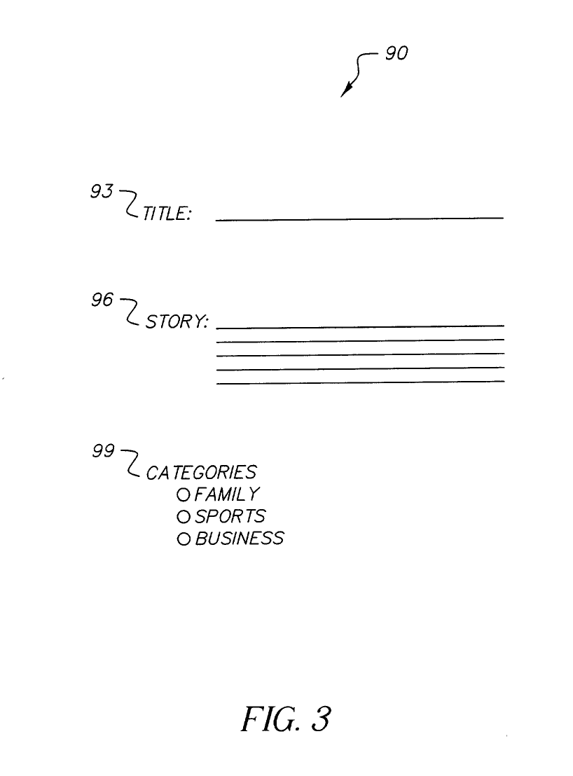

Referring to FIG. 2, there is shown an illustration of a typical webpage 60 of a website of the present invention. The webpage 60 includes a plurality of color thumbnail images (low-resolution images) 70 positioned in an adjacent side-by-side manner, hereinafter collectively referred to as a photoquilt 75. These thumbnails images 70 are not, however, discernible when viewed therefrom. These images 70 may be made disceruable by clicking a zoom on icon 76 and returned to the their original state by clicking a zoom-out icon 77. Each image 70 includes an embedded link to either a third-party website or a high-resolution version of the image, as described in detail hereinbelow. It is instructive to note that the original images are submitted by consumers. In this regard, the user would click on a tab 80 at a top portion of the webpage 60 and follow the illustrated directions therein. Referring briefly to FIG. 3, there is shown an example of typical instructions 90. The instructions include a title section 93 for the title, a story section 96 for a short narrative of the image, and a predefined category section 99 from which the user indicates the one or more applicable categories. Independent of submitting images to the website, the owner of the photographs creates their own website, or on-line photopages, related to the submitted image that may be accessed from the website, as described hereinbelow. These photopages are a collection of images arranged in a predetermined manner. This user-created website resides on a server and may be implemented and maintained by any of a number of commercially available web-hosting companies.

The images and text information are reviewed by the owner of the website for searching for undesirable images and text, such as obvious copyrighted images and text, morally undesirable images and text and the like. After this review, the low-resolution images, high-resolution images and text (title 93 and story 96) are input into the website. As will be obvious to those skilled in the art, such software for submitting the images and text and inputting them into the website can be accomplished by those skilled in the art without an undue burden.

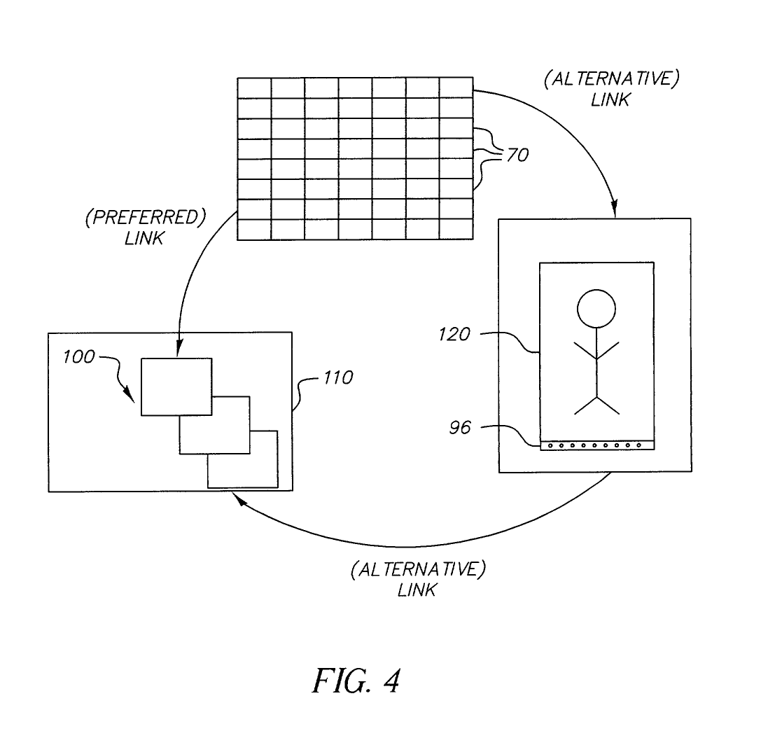

Referring to FIG. 4, there is shown an illustration of the various links from the thumbnail images 70. To obtain further information about an image 70, the selector 52 is moved over the 70 image and the mouse 50 is clicked which actives the embedded link for preferably viewing a third-party website 100 residing on a server 110. The third-party website 100 includes a plurality of webpages or photopages that may be viewed for obtaining further information. As may be apparent, the images 70 are a visual indication or representation of a subject matter for which the user wishes to search the photopages. Alternatively, when the mouse 52 is clicked, a high-resolution version of the image 120 along with story text 96 is displayed. This high-resolution image 120 also contains a link to the third-party website 100, and likewise when the selector 52 is moved over the high-resolution image 120, the link is activated for linking to the third-party website 100.

In addition to the visual searching via the images, the user may search via a keyword. The inputted keyword causes the text of the narrative stories to be searched and displays in a preferred manner, such as by the number of hits, the related websites that may then be accessed. Similarly, the user may search by inputting a category that causes the categories to search for any matches. This information is then displayed for access, if desired.

The invention has been described in detail with particular reference to certain preferred embodiments thereof, but it will be understood that variations and modifications can be effected within the spirit and scope of the invention.

What is claimed is:

1. A website accessible on the Internet comprising:
(a) a plurality of images submitted by a third party and arranged in a predetermined configuration on the website; and
(b) an embedded link in one or more of the images each link respectively corresponding to one of a plurality of third party photopages created by the third party, and the link is activated when a user indicates a preference for one of the images.

2. The website as in claim 1, wherein the plurality of images are low-resolution images.

3. The website as in claim 2 further comprising a graphical user interface that is used for indicating the user preference.

4. The website as in claim 2, wherein the link includes linking to the third-party photopages having a plurality of webpages.

5. A website accessible on the Internet comprising:
(a) a plurality of low-resolution images submitted by a third party and arranged in a predetermined configuration on the website;
(b) a plurality of high-resolution images respectively corresponding to a low-resolution image;
(c) a first embedded link in one or more of the low-resolution images each link respectively corresponding one of the high-resolution images, and the first link is activated when a user indicates a preference for one of the images;
(d) a second embedded link in one or more of the high-resolution images each link corresponding to one of a plurality of third party photopages created by the third party, and the second link is activated when a user indicates a preference for one of the images.

6. The website as in claim 5 further comprising a graphical user interface that is used for indicating the user preference.

7. The website as in claim 5, wherein the second link includes linking to the third-party website having a plurality of webpages.
